(19) United States
(12) Patent Application Publication
(10) Pub. No.: US 2015/0189557 A1
(43) Pub. Date: Jul. 2, 2015

(54) Network-Controlled UE Switching between Different Types of Radio Networks

(71) Applicants: Samy Touati, San Jose, CA (US); Gunnar Mildh, Sollentuna (SE); Jari Vikberg, Jarna (SE); Erik Westerberg, Enskede (SE)

(72) Inventors: Samy Touati, San Jose, CA (US); Gunnar Mildh, Sollentuna (SE); Jari Vikberg, Jarna (SE); Erik Westerberg, Enskede (SE)

(73) Assignee: Telefonaktiebolaget L M Ericsson (publ), Stockholm (SE)

(21) Appl. No.: 14/414,140

(22) PCT Filed: Jul. 13, 2012
(86) PCT No.: PCT/SE2012/050834

§ 371 Date: Jan. 12, 2015

(51) Int. Cl. H04W 36/00; H04W 48/16

(52) U.S. Cl. CPC H04W 36/0066; H04W 48/16; H04W 36/30

(57) ABSTRACT

Auser equipment, UE, (16) with established radio communications service with a first type of radio network (10), receives from the first network information including parameters for scanning for radio access points in a second type of radio network (12) different from the first type. The UE scans access points in the second type of radio network based on the received information and detects access point data and reports the detected access point data to the first type of radio network. Subsequently, the UE receives a signal from the first network to switch radio communications service from the first network to one of the access points in the second network. In response to the received signal, the UE switches radio communications service from the first network to one of the access points in the second network.

### TECHNICAL FIELD

The technology relates to radio communications, and in particular, to coordinating user equipment (UE) communications across different types of radio networks.

### BACKGROUND

Heterogeneous radio access networks allow mobile radio communications operators to move traffic from a macro cellular radio network, where the capacity is sometimes limited, to cheaper shorter range wireless local area networks (WLANs) and femto/picocell networks connected over a variety of backhaul connections. Mobile radio connectivity thus may involve a mixture of radio, backhaul, and core network technologies, which require more complex inter-operator roaming agreements and emerging technologies.

3rd Generation Partnership Project (3GPP) establishes technical specifications for cellular radio communications. 3GPP also specifies mechanisms allowing non-3GPP accesses to connect to evolved packet core (EPC) networks at a packet data network-gateway (PDN-GW) using S2a, S2b, and S2c interfaces. These interfaces can be used by a 3GPP UE to attach to the PDN-GW (via wireline infrastructure) using Wi-Fi as access technology (Wi-Fi is the name given to the technology outlined in the IEEE 802.11 family of technical specifications). Prior to association to a Wi-Fi network, the UE must perform a network discovery and selection procedure. Both 3GPP and the Wi-Fi Alliance provide mechanisms that allow a UE to perform the discovery and selection procedures.

A 3GPP mechanism is the Access Network Discovery and Selection Function (ANDSF) defined by 3GPP. See 3GPP TS 23.402, the contents of which are incorporated herein by reference. An ANDSF either pushes to the UE or has the UE pull a set of rules that the UE uses to for scanning for Wi-Fi access based on the UE's location. Hot-Spot 2.0 (HS2.0) defined by the Wi-Fi Alliance, also incorporated herein by reference, is a network discovery and selection mechanism based on IEEE 802.11u. An HS2.0 objective is to allow a UE to seamlessly associate with a Wi-Fi access point based on a set of rules pre-installed on the UE. Hot-Spot 2.0 certification also provides a standardized mechanism for secure authentication and streamlined new user account creation at the hot-spot location.

The inventors recognized that 3GPP/Wi-Fi interworking mechanisms like ANDSF and Wi-Fi Alliance Hot-Spot 2.0 provide complementary mechanisms for integrated use of WLAN-based and cellular-based access networks. They also recognized that technology which leverages both types of mechanisms can provide increased integration, better performance, higher efficiency, better and more flexible services, etc.

### SUMMARY

A user equipment, UE, after establishing radio communications service with a first type of radio network, receives from the first type of radio network information including parameters for scanning for radio access points in a second type of radio network different from the first type of radio network. The UE scans access points in the second type of radio network based on the received information and detecting access point data and reports the detected access point data to the first type of radio network. In response to receiving a signal from the first type of radio network to switch radio communications service from the first type of radio network to one of the access points in the second type of radio network, the UE switches radio communications service from the first type of radio network to one of the access points in the second type of radio network.

Preferably, the switching of the radio communications service is a network-directed handover of the UE from the first type of radio network to one of the access points in the second type of radio network. For example, a situation may be detected indicating that the UE should begin the scanning step, and in response, the UE scans access points in the second type of radio network based on the received information and detecting access point data. The situation may include a weakening of signal strength or a lessening of signal quality from the first type of radio network.

The scanning parameters, for example, may include one or more rules indicating under what conditions the UE should scan access points and what specific information the UE should obtaining from the scanning and report to the first type of radio network. Example rules define one or more of the following: a frequency of scanning by the UE, a threshold defining a minimum signal parameter to initiate the scanning, a UE battery level to initiate the scanning, an application type on the UE to initiate the scanning, data processing unit utilization level, an UE accelerometer value to initiate the scanning, a UE position to initiate the scanning, or a mobility state of the UE to initiate the scanning Examples of the specific information include one or more of: a load of one or more access points in the second type of radio network, one or more supported roaming partners, a type of network security provided by the second type of radio network, a radio link performance associated with one or more access points in the second type of radio network, or a backhaul transport network performance of one or more access points in the second type of radio network.

In an example embodiment, the first type of radio network is a cellular radio network and the second type of radio network is a wireless local area network, WLAN. A non-limiting example is provided below where the cellular radio network is a 3GPP cellular radio network and the WLAN is a Wi-Fi network based on one or more IEEE 802.11 protocols. In a more detailed non-limiting example, the 3GPP cellular network includes an Access Network Discovery and Selection Function, ANDSF, which either pushes to the UE or has the UE pull a set of rules to be used by the UE to start scanning for Wi-Fi access, and wherein the specific information includes IEEE 802.11u PassPoint Access Network Query Protocol, ANQP, elements.

Another aspect includes a network node in the first type of radio network providing radio communications service to the UE. The network node sends to the UE information including parameters indicating how the UE is to scan for radio access points in a second different type of radio network separate from the first type of radio network. As a result, the network node receives from the UE access point data detected by the UE scanning access points in the second type of radio network in accordance with the sent information. The network node sends a signal to the UE instructing the UE to switch radio communications service from the first type of radio network to one of the access points in the second type of radio network based on the received access point data from the UE.

### BRIEF DESCRIPTION OF THE DRAWINGS

FIG. 1 illustrates an example scenario where UEs may communicate with different types of radio networks;

FIG. 2 is a flowchart illustrating non-limiting example steps performed by a UE in accordance with an example embodiment;

FIG. 3 is a flowchart illustrating non-limiting example steps performed by a network node in accordance with an example embodiment;

FIG. 4 illustrates a non-limiting example scenario where a UE communicates with a cellular radio network and a WLAN network;

FIG. 5 is a non-limiting example function block diagram of a UE;

FIG. 6 is a non-limiting example function block diagram of a network node;

FIG. 7 is a non-limiting example signaling diagram; and

FIG. 8 is a non-limiting example of a multi-access handover.

### DETAILED DESCRIPTION

The following description sets forth specific details, such as particular embodiments for purposes of explanation and not limitation. But it will be appreciated by one skilled in the art that other embodiments may be employed apart from these specific details. In some instances, detailed descriptions of well known methods, nodes, interfaces, circuits, and devices are omitted so as not to obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, the technology can additionally be embodied within any form of non-transitory, computer-readable memory, such as solid-state memory, magnetic disk, or optical disk containing an appropriate set of computer instructions that would cause one or more processors to carry out the techniques described herein.

Thus, for example, it will be appreciated by those skilled in the art that block diagrams herein can represent conceptual views of illustrative circuitry or other functional units embodying the principles of the technology. Similarly, it will be appreciated that any flow charts, state transition diagrams, pseudocode, and the like represent various processes which may be implemented by computer program instructions that may be stored in a non-transitory, computer-readable storage medium and which when executed by one or more computers or processors cause the processes to be performed, whether or not such computer(s) or processor(s) is(are) explicitly shown.

Hardware implementation may include or encompass, without limitation, digital signal processor (DSP) hardware, a reduced instruction set processor, hardware (e.g., digital or analog) circuitry including but not limited to application specific integrated circuit(s) (ASIC) and/or field programmable gate array(s) (FPGA(s)), and (where appropriate) state machines capable of performing such functions.

In terms of computer implementation, a computer is generally understood to comprise one or more processors or one or more controllers, and the terms computer, processor, and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

The functions of the various elements including functional blocks, including but not limited to those labeled or described as a computer, processor, or controller, may be provided through the use of hardware such as circuit hardware and/or hardware capable of executing software in the form of coded instructions stored on non-transitory, computer-readable medium. Thus, such functions and illustrated functional blocks are to be understood as being either hardware-implemented and/or computer-implemented, and thus machine-implemented.

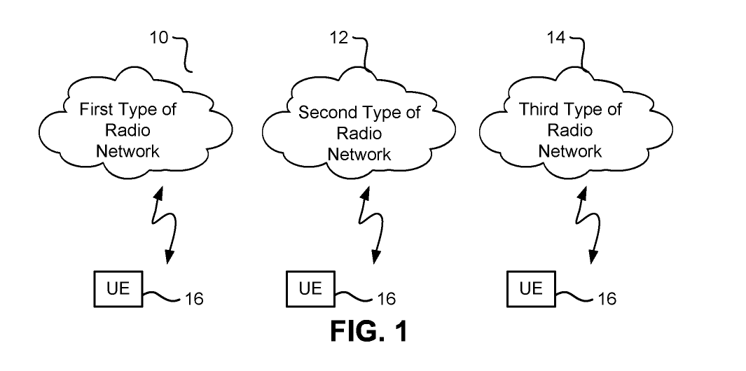

FIG. 1 shows an example situation where UEs 16 may potentially obtain radio access and communications services via multiple different types of radio access networks that allow UEs to communicate with other networks such as the Internet, the PSTN, private networks, etc. A first type of radio network 10, a second type of radio network 12, and a third type of radio network 14 are shown. Examples of different types of radio networks include cellular networks, public WLANs, private WLANs (business, home, etc.), etc. Other types of radio access networks are included, e.g., WiMAX. The technology described integrates multiple technical features from different types of radio access networks, and as a result, leverages multiple radio access technologies to provide a more integration, better performance, higher efficiency, better and more flexible services, among other advantages.

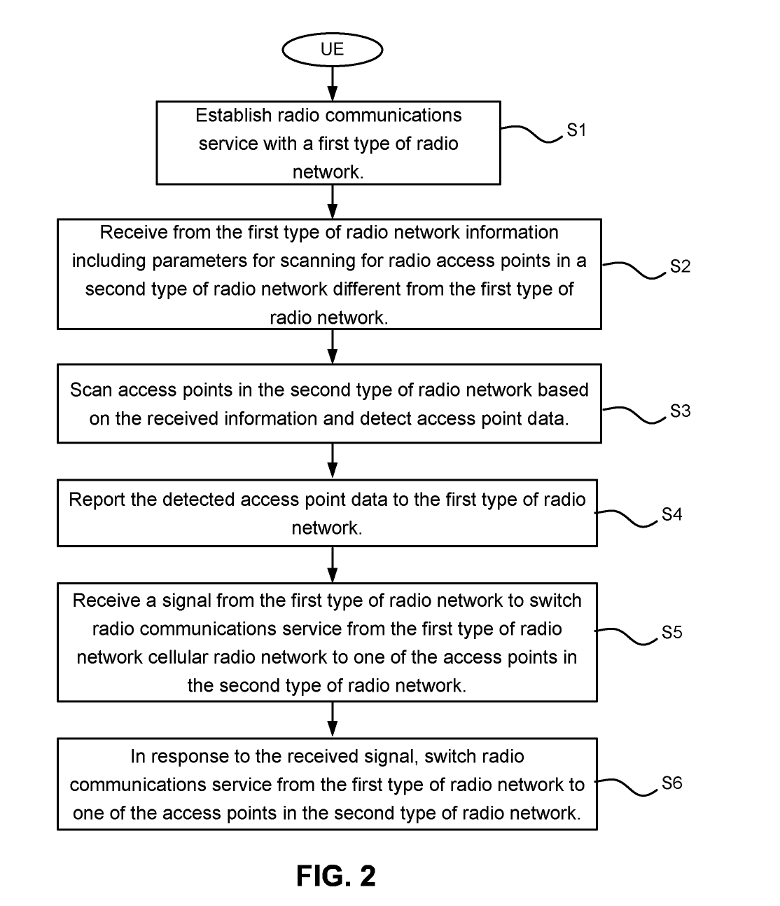

FIG. 2 is a flowchart illustrating non-limiting example steps performed by a UE in accordance with an example embodiment. In step S1, the UE establishes (or has already established) radio communications service with a first type of radio network. At some point, the UE receives from the first type of radio network information including parameters and trigger points for scanning for radio access points in a second type of radio network different from the first type of radio network (step S2). An access point (AP) is any radio node that provides access to a radio access network. The UE later scans access points in the second type of radio network based on the received information and detects access point data (step S3). The UE reports the detected access point data to the first type of radio network (step S4) and receives a signal from the first type of radio network to switch radio communications service from the first type of radio network cellular radio network to one of the access points in the second type of radio network (step S5). The signal to switch from the first type of radio network to one of the access points in the second type of radio network occurs when a radio condition associated with the access with the first type of network warrants the switch such as when the signal strength received from the first type of radio network is decreasing or the load of the first type of radio network is increasing. In response to the received signal, the UE switches radio communications service from the first type of radio network to one of the access points in the second type of radio network (step S6).

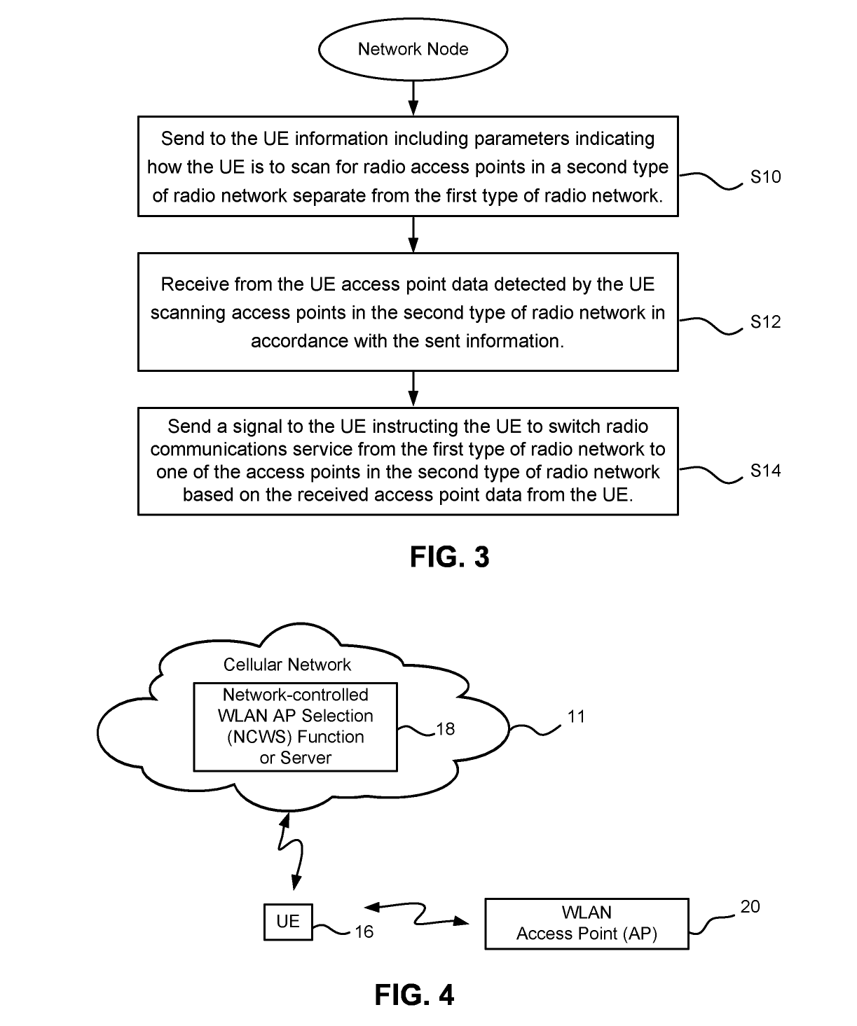

FIG. 3 is a flowchart illustrating non-limiting example steps performed by a network node in accordance with an example embodiment in cooperation with the UE's operation outlined in FIG. 2. The network node may be for example a base station node, a base station control node, a core network node, a standalone server node, or other type of network node. The network node initially sends to the UE information including parameters indicating how the UE is to scan for radio access points in a second type of radio network separate from the first type of radio network (step S10). The network node receives from the UE access point data detected by the UE scanning access points in the second type of radio network in accordance with the sent information (step S12). The network node sends a signal to the UE instructing the UE to switch radio communications service from the first type of radio network to one of the access points in the second type of radio network based on the received access point data from the UE (step S14).

FIG. 4 illustrates a non-limiting example scenario where a UE 16 communicates with both a cellular radio network 11 and a WLAN network 20 which are examples of two different types of radio access networks. Examples of cellular radio networks include 3GPP networks like GERAN, UTRAN, HSPA and e-UTRAN/LTE, and an example of a WLAN network is a Wi-Fi network in the IEEE 802.11 series and WiMAX based on 802.16. The WLAN network 20 includes at least one and typically multiple access points (APs). The cellular radio network 11 includes a network-controlled WLAN AP selection (NCWS) function 18 that may be implemented as part of an existing network node in the cellular network 11 or as a part of a new node or computer server associated with the cellular radio network 11.

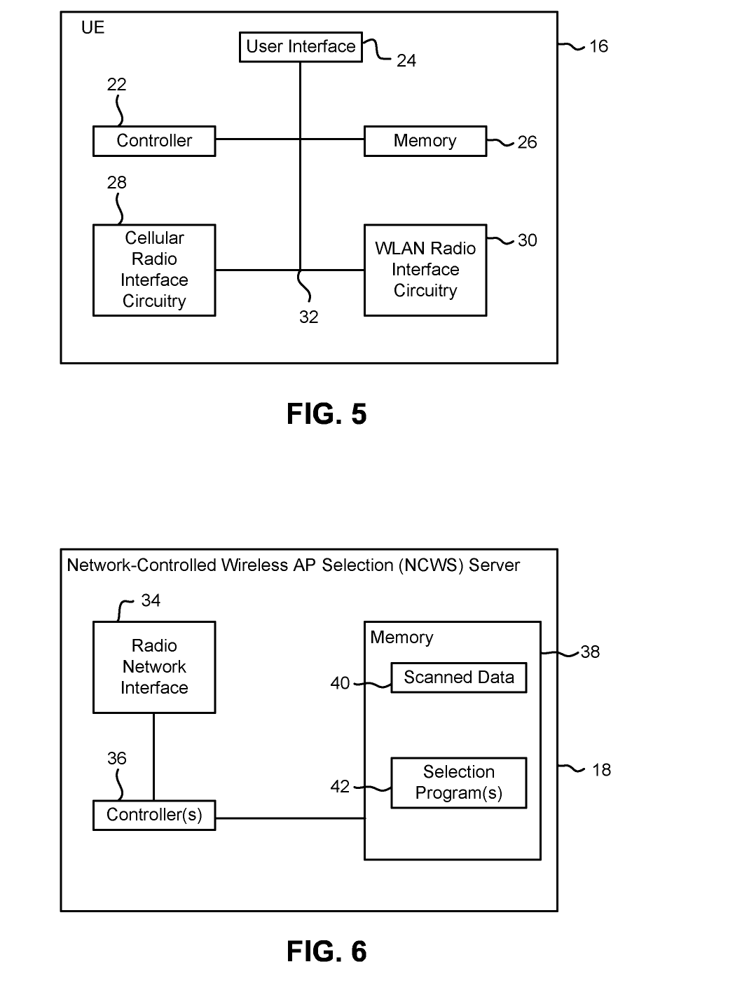

FIG. 5 is a non-limiting example function block diagram of a UE for implementing the steps in FIG. 2 as well as for implementing UE procedures outlined in the detailed non-limiting examples described below. The UE 16 includes a user interface 24, controller 22, memory 26, first radio interface circuitry 28, and second radio interface circuitry 30 all connected by one or more data communication busses 32. The controller 22 may be one or more data processors controlled in whole or in part by one or more computer programs stored in one or more memories 26 for controlling/implementing the UE functions described above in FIG. 2 and below. The memory also stores data such as specific parameters for scanning for radio access points received from a radio network or otherwise and rules for selecting an access point when a handover is necessary or desired. The UE may scan access points for example when the UE detects sufficient weakening of signal strength or lessening of signal quality from the cellular radio network, e.g., as compared to a threshold. The first radio interface circuitry 28 and second radio interface circuitry 30 include radio transceiving and baseband processing functionality required for radio communication with a first type of radio network, e.g., a cellular network, and a second type of radio network, e.g., a WLAN network. Although the first radio interface circuitry 28 and second radio interface circuitry 30 are show as separate blocks, they may be implemented together or in other suitable configurations. Some or all of the functionality in the UE may be implemented using hardware such as FPGAs, ASICs, discrete components, etc.

FIG. 6 is a non-limiting example function block diagram of a network node 18 for implementing the steps in FIG. 3 as well as for implementing network node procedures outlined for detailed non-limiting examples described below. The network node 18 includes a radio network interface 34, one or more controllers 36, and one or more memories 38 connected by one or more busses. The controller 36 may be one or more data processors controlled in part by one or more computer programs stored in one or more memories 38 for controlling/implementing the network node functions described above in FIG. 3 and below. The one or more memories 38 store access point selection program instructions 42 and scan data 40 such as scanning rules sent to UEs and scanned information received from one or more UEs 16. As mentioned above for the UE 16, some or all of the functionality in the network node 18 may be implemented using hardware such as FPGAs, ASICs, discrete components, etc.

For the UE 16 and network node 18, scanning parameters may include one or more rules indicating under what condition(s) the UE should scan access points and what specific information the UE should obtain from the scanning and then report to the cellular radio network. For example, they may define one or more of the following: a frequency of scanning by the UE, a threshold defining a minimum signal parameter to initiate the scanning, a UE battery level to initiate the scanning, an application type on the UE to initiate the scanning, an UE accelerometer value to initiate the scanning, a UE position to initiate the scanning, or a mobility state of the UE to initiate the scanning Examples of information the UE may obtain during scanning and report to the network node may include one or more of: a load of one or more access points in the WLAN, one or more supported roaming partners, a type of network security provided by the WLAN, a radio link performance associated with one or more access points in the WLAN, or a backhaul transport network performance of one or more access points in the WLAN.

The following describes non-limiting example embodiments in a specific context where a first type of radio network is a 3GPP cellular radio network and a second type of radio network is a WLAN network corresponding to a Wi-Fi network based on one or more IEEE 802.11 protocols.

In this example context, the inventors determined that 3GPP's existing Access Network Discovery and Selection Function (ANDSF) is not sufficiently flexible or comprehensive because the existing ANDSF rules only allow UEs to associate with a Wi-Fi access point based on a list of service set identifiers (SSID), (each SSID is a MAC address for a corresponding Wi-Fi access point), available for the UE in a particular geographical location. For example, no selection rules are pushed to the UE to allow the UE to select a Wi-Fi Access Point network based on other criteria such as a load of the access point, supported roaming partners, the type of IP network security provided, radio link performance, and/or backhaul transport network performance of the access point. But the inventors recognized that Hot-Spot 2.0 certification provides access to these additional types data and that the discovery and selection mechanisms in Hot-Spot 2.0 are based on the collected data evaluation during a discovery phase prior to associating to any Access Point.

But there are also shortcomings in the HS2.0 selection mechanism. For example, it is based on a pre-provisioned set of rules stored in the UE that can be overridden by the user from a connection manager. Another shortcoming is the selection mechanism may only be enabled when the UE, or the user, activates a Wi-Fi interface to start scanning for a homogeneous extended SSID (HESSID). These shortcomings limit the effectiveness of HS2.0 selection results because the pre-provisioned rules are not network-managed or dynamic. The rules are network-managed so as to allow the network to steer the UE regarding radio access network to use. Accordingly, the network needs an overall view of different radio conditions across the multiple radio access technologies deployed. The network directing the steering allows optimization in directed the UE to an Access Point and transfers ome context data from the source access to the target access reducing the handover time. The rules are also dynamic to account for changing radio conditions and network conditions when steering the UE to the most optimal access when required. Therefore threshold for the different rules varies over time depending the variable radio and network conditions.

On the other hand, the ANDSF does support a network-controlled architecture to deliver network-managed policies, which can be refreshed and revised by the network as desired. Those policies may also be personalized based on the knowledge of the user if required. Accordingly, the technology in this example embodiment combines or integrates capabilities of HS2.0 and the ANDSF. For example, the ANDSF is augmented using HS2.0 functionality to include rules that provide a Wi-Fi network selection procedure based on data obtained from access points prior to UE authentication with a selected access point. The augmented rules may also be used as part of Wi-Fi's Inter-System Mobility Policies (ISMP) and Inter-System Routing Policies (ISRP). As a result, the 3GPP network can direct a UE switch, e.g., a handover, from 3GPP access to Wi-Fi access taking into account a variety of HS2.0 parameters, which is not possible with currently-defined mechanisms for network discovery and selection.

In this example context, the network node 18 is a 3GPP node or server includes a network-controlled Wi-Fi AP selection (NCWS) function corresponding to an augmented Access Network Discovery and Selection Function (ANDSF). The NCWS function may also reside in different parts of the 3GPP network such as part of the RAN, the core network (CN), or a service network. The NCWS either pushes to the UE or has the UE pull information (e.g., one or more sets of rules) to be used by the UE in scanning for Wi-Fi access UE to collect HS2.0 type information on different Wi-Fi APs. Based on this information from the network node, the UE may place its Wi-Fi radio interface circuitry into an HS2.0 scanning mode to allow the UE to perform a network discovery phase and probe APs in its vicinity using HS2.0 mechanisms. In this mode, the UE preferably does not associate to any Wi-Fi access point and hence stays connected to the 3GPP network. In this way, the 3GPP network controls handover to a particular Wi-Fi AP using a comprehensive platform of information to optimize the timing of the handover and the AP selected. As a result, this technology provides overall better end-user performance because the network type switch and AP selection take into consideration a variety of parameters like the load situation both in the source and target cells, radio conditions, ownership of the target Wi-Fi access point, and/or other factors.

As mentioned above, two types of rules may be pushed from the “network controlled Wi-Fi Access selection” function in the 3GPP network to the UE. One set of rules includes scanning conditions examples of which include one or more of the following:

1-a frequency of scanning operation. In between two scans the Wi-Fi radio can be turned off to save battery in the UE.

2-one or more thresholds defining the minimum signal strength of the 3GPP RAN to trigger a start of a Wi-Fi AP scan.

3-scanning based on battery level on the UE.

4-scanning based on the application type on the UE.

5-scanning based on data from the accelerometer in the UE if available.

6-scanning based on UE position

7-scanning based on the UE mobility (e.g. moving, stationary)

Other rules based on other parameters may also be used. Different rules may be used in different scenarios and implementations.

Another set of rules includes specific HS2.0 parameters that UEs should obtain from discovered access points referred to below as Wi-Fi scan data rules. The UE may use, in an example embodiment, 802.11u-based signaling to perform these queries on the different access points with SSIDs in one or more HESSIDs. These queried parameters may either all be reported back to the 3GPP network or a partial list may be reported back. Examples of HS2.0 parameters include Basic Service Set, BSS, Load of the Access Point, Received Signal Strength Indicator, RSSI, at the UE, Wide Area Network, WAN, Metrics, Operating Class, and Access Network Type.

The 3GPP RAN may send an access selection command or handover request to a UE ordering the UE to access a specific Wi-Fi access point selected by the 3GPP network node because, e.g., the AP fulfills certain criteria such as a load lower than a specified value, a signal strength stronger than a specific value, etc. The access point selection command to the UE may contain information outlining one or more conditions when the UE should connect to the selected Wi-Fi access point.

The associated signaling load on the UE and on the network may be controlled by limiting how often such rules, parameters, and/or conditions are updated. For example, only delta/difference information need be sent for updates. Similarly UE scan results may be reported to the network in terms of deltas from previous reports to reduce the signaling load. Triggering of reports may be periodic or event or condition-triggered or both. The scanning condition rules and reporting rules may be communicated to the UE either as broadcast information, as dedicated signaling, as pre-configured data, or some combination of these methods.

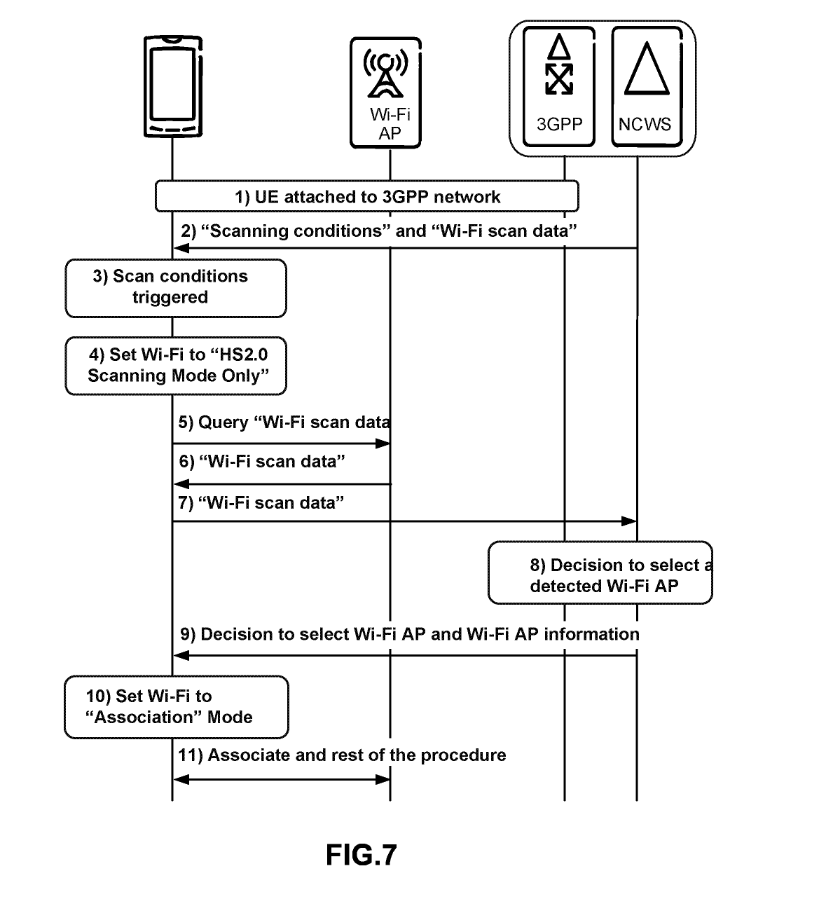

FIG. 7 is a non-limiting example signaling diagram for a sequence of events that take place prior to a UE handover from the 3GPP network to a Wi-Fi AP. In 1), the UE is attached to the 3GPP network. At 2), the UE is pushed/receives information, e.g., a set of rules, pertaining to the Wi-Fi access networks from the network controlled Wi-Fi Access selection function in the 3GPP RAN. These rules include scanning condition rules and the Wi-Fi scan data that the UE is to report back to the 3GPP network. 3) the UE detects low signal strength from the 3GPP RAN that matches one of the rules indicating that the UE should start scanning for Wi-Fi access points. The signal strength level condition may be set so that it is always met, i.e., it is set very high so that the UE always detects the 3GPP network signal below the threshold rule to scan for WiFi APs. This may be useful in offload scenarios when the signal strength of the 3GPP cell is not an important handover decision factor. The UE may also scan Wi-Fi APs when the signal strength from the 3GPP RAN is strong. In some situations, scanning may be triggered by the network-controlled Wi-Fi Access selection function sending an explicit scan command to the UE. 4) The UE powers on its Wi-Fi interface and starts scanning, but does not associate to any of the scanned Access Points as no decision has been taken by the network to perform handover. 5) Scanning by the UE begins, and the UE queries HS2.0 data from different APs in the HESSID listed in the Wi-Fi scan data. 6) The UE receives queried data from scanned access points, and 7) reports the collected data to the “network controlled Wi-Fi Access selection” function in the 3GPP network according to the Wi-Fi scan data rules.

This reporting and the provisioning of the set of rules to the UE may take place on different levels. For example, it may be part of radio resource control (RRC) or non-access stratum (NAS) signaling or as part of an IP-level communication in the user plane of the 3GPP network.

At point 8), the 3GPP network node determines that a handover is desired or required and initiates at 9) the handover procedure by instructing the UE to associate to a neighboring access point, e.g., the MAC address of the AP is provided to the UE. The handover and selected AP information are based on the previously reported data by the UE. At 10), the UE controller places the Wi-Fi radio interface circuitry in “associate mode,” which is the regular mode for Wi-Fi radio communications. At 11), the UE selects the instructed Wi-Fi frequency and channel based on the received handover information. The UE starts the association and authentication procedure with the selected access point. At this point in time, there is no need to perform discovery as defined by HS2.0, as the network has already collected the discovery information at step 7. HS2.0 selection takes place where the UE associates with the network selected AP and starts an authentication procedure.

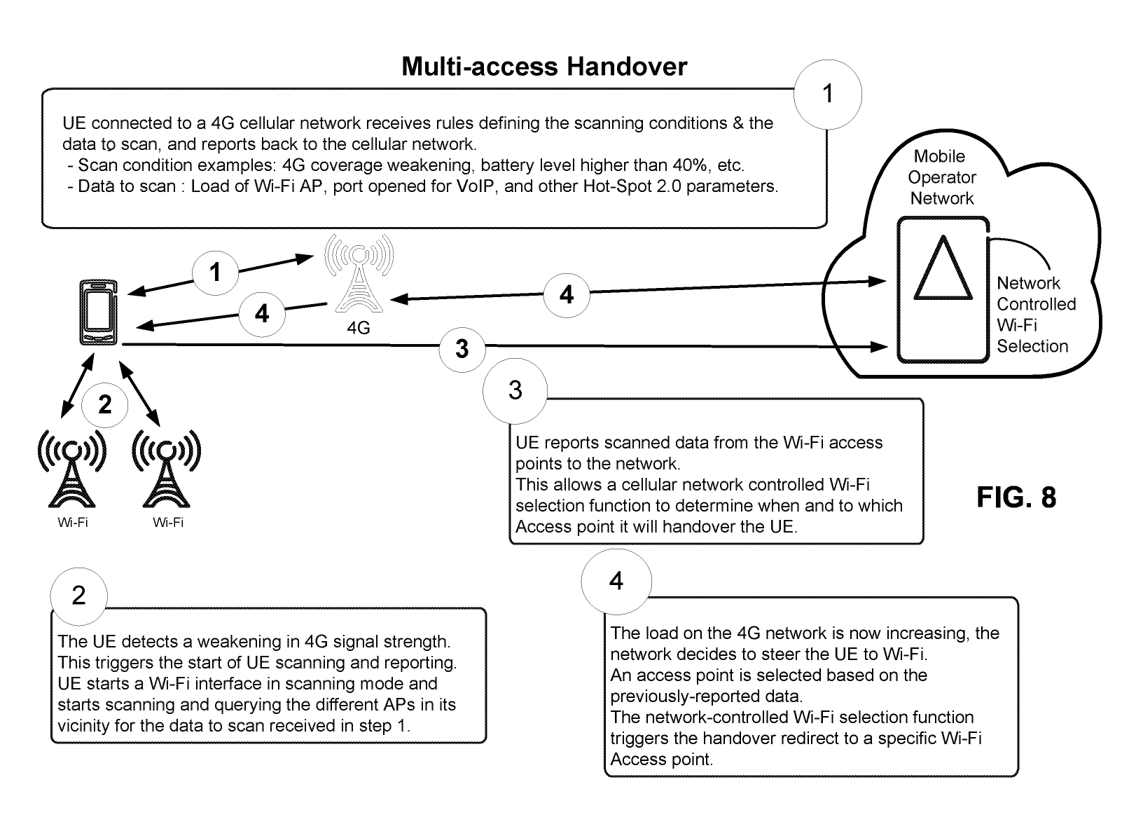

FIG. 8 is a non-limiting example of a multi-access handover. At time (1), the UE is connected to a 4G LTE cellular network. The UE receives from the cellular network rules defining the scanning conditions and specific data to scan and report back to the network. Example start scanning conditions might include weakening of 4G coverage or a UE battery level is higher than 40% (higher battery level allows more flexibility in starting scans and potentially handing over given that handover consumes more energy because of the signaling involved). Example data to scan includes the current load of the Wi-Fi AP, whether the AP has a port open for voice over IP (VoIP), and other Hot-Spot 2.0 parameters. At time (2), the UE notices a weakening in 4G signal strength which triggers start of AP scanning and reporting. The UE puts its Wi-Fi interface in scanning mode and starts scanning and querying the different APs in its vicinity for the scan data identified in step (1). At time (3), the scanned data the UE obtained from the scanned Wi-Fi access points is reported to the 3GPP network node which uses this information to perform a network-controlled Wi-Fi AP selection function that determines when to handover the UE and to which specific access point. At time (4), the load on the 4G network increases to a point where the 3GPP network node decides to steer the terminal to the Wi-Fi network. A particular access point is selected based on the previously-reported data, and the network controlled Wi-Fi selection function triggers the handover redirect to a specific Wi-Fi access point.

There are significant advantages to a network-controlled handover as compared for example to a UE-directed handover or a default Wi-Fi handover. For example, the 3GPP cellular network may be loaded, but still able to handle some type of traffic such as web traffic or chat applications. In that case, a video streaming application may be handled via the Wi-Fi access but the web and chat remain with the cellular network. Another advantage of network-controlled handover to Wi-Fi is the ability to trigger a handover to Wi-Fi when the load of the Wi-Fi network is warrant that handover. Absent this technology, the UE by default associates with Wi-Fi if it is available and provides a suitable signal strength. In this way, less desirable handovers from a cellular network to a Wi-Fi network may be reduced. Network-directed handovers lead to better utilization of radio resources (spectrum efficiency) and better end user performance because handover decisions are taken with knowledge of the full network load and radio conditions of all mobiles in the network rather than taken with the limited knowledge a UE has about its own radio situation and load situation of the target Wi-Fi access point. The technology also improves integration between cellular and other types of networks which is necessary for deploying other networks, like Wi-Fi networks, in a high-density manner. Another advantage is the technology saves battery in the UE by enabling the network to inform the UE when the Wi-Fi radio circuitry may be powered-off in between scanning periods.

Although the description above contains many specifics, these should not be construed as limiting the scope of the claims but as merely providing illustrations of example embodiments. It will be appreciated that the technology claimed fully encompasses other embodiments which may become apparent to those skilled in the art, and that the scope of the claims is accordingly not to be limited. Reference to an element in the singular is not intended to mean “one and only one” unless explicitly so stated, but rather “one or more.” All structural and functional equivalents to the elements of the above-described embodiments that are known to those of ordinary skill in the art are expressly incorporated herein by reference and are intended to be encompassed hereby. Moreover, it is not necessary for a device or method to address each and every problem sought to be solved for it to be encompassed hereby. No element, block, or instruction used in the present application should be construed as critical or essential to the implementations described herein unless explicitly described as such. Further, the phrase “based on” is intended to mean “based, at least in part, on” unless explicitly stated otherwise. Unclaimed subject matter is not dedicated to the public and Applicant reserves all rights in unclaimed subject matter including the right to claim such subject matter in this and other applications, e.g., continuations, continuations in part, divisions, etc.

1-30. (canceled)

31. A method in a user equipment (UE) for conducting radio communications, the method comprising:
establishing radio communications service with a radio network of a first type;
receiving, from the radio network of the first type, information including parameters for scanning for radio access points in a radio network of a second type different from the radio network of the first type;
scanning access points in the radio network of the second type, based on the received information, and detecting access point data;
reporting the detected access point data to the radio network of the first type;
receiving a signal from the radio network of the first type to switch radio communications service from the radio network of the first type to one of the access points in the radio network of the second type; and
in response to the received signal, switching radio communications service from the radio network of the first type to one of the access points in the radio network of the second type.

32. The method in claim 31, further comprising:
detecting a situation indicating that the UE should begin the scanning step, and
in response to the detected situation, scanning access points in the radio network of the second type, based on the received information, and detecting access point data.

33. The method in claim 32, wherein the situation includes a weakening of signal strength or a lessening of signal quality from the radio network of the first type.

34. The method in claim 31, wherein the switching of the radio communications service is a network-directed handover of the UE from the radio network of the first type to one of the access points in the radio network of the second type.

35. The method in claim 31, wherein the scanning parameters include one or more rules indicating under what conditions the UE should scan access points and what specific information the UE should obtaining from the scanning and report to the radio network of the first type.

36. The method in claim 35, wherein the one or more rules define one or more of the following: a frequency of scanning by the UE, a threshold defining a minimum signal parameter to initiate the scanning, a UE battery level to initiate the scanning, an application type on the UE to initiate the scanning, a data processing unit utilization level, an UE accelerometer value to initiate the scanning, a UE position to initiate the scanning, and a mobility state of the UE to initiate the scanning.

37. The method in claim 36, wherein the specific information includes one or more of: a load of one or more access points in the radio network of the second type, one or more supported roaming partners, a type of network security provided by the radio network of the second type, a radio link performance associated with one or more access points in the radio network of the second type, and a backhaul transport network performance of one or more access points in the radio network of the second type.

38. The method in claim 37, wherein the radio network of the first type is a cellular radio network and the radio network of the second type is a wireless local area network (WLAN).

39. The method in claim 38, wherein the cellular radio network is a 3GPP cellular radio network and the WLAN is a Wi-Fi network based on one or more IEEE 802.11 protocols.

40. The method in claim 39, wherein the 3GPP cellular network includes an Access Network Discovery and Selection Function (ANDSF) which either pushes to the UE or has the UE pull a set of rules to be used by the UE to start scanning for Wi-Fi access, and wherein the specific information includes IEEE 802.11u PassPoint Access Network Query Protocol (ANQP) elements.

41. A method in a network node in a radio network of a first type in which radio communications service is provided by the radio network of the first type to a user equipment (UE), the method comprising:
sending, to the UE, information including parameters indicating how the UE is to scan for radio access points in a radio network of a second type different from the radio network of the first type;
receiving, from the UE, access point data detected by the UE scanning access points in the radio network of the second type in accordance with the sent information; and
sending a signal to the UE instructing the UE to switch radio communications service from the radio network of the first type to one of the access points in the radio network of the second type, based on the received access point data from the UE.

42. The method in claim 41, wherein the switch is a network-controlled handover of the UE from the radio network of the first type to one of the access points in the radio network of the second type.

43. The method in claim 41, wherein the information includes specific conditions at which the UE should begin scanning access points in the radio network of the second type.

44. The method in claim 43, wherein the specific conditions include a weakening of signal strength or a lessening of signal quality from the radio network of the first type.

45. The method in claim 43, wherein the specific conditions include one or more rules that define one or more of the following: a frequency of scanning by the UE, a threshold defining a minimum signal parameter to initiate the scanning, a UE battery level to initiate the scanning, an application type on the UE to initiate the scanning, a data processing unit utilization level, an UE accelerometer value to initiate the scanning, a UE position to initiate the scanning, and a mobility state of the UE to initiate the scanning.

46. The method in claim 45, wherein the received UE access point data includes one or more of: a load of one or more access points in the radio network of the second type, one or more supported roaming partners, a type of network security provided by the radio network of the second type, a radio link performance associated with one or more access points in the radio network of the second type, and a backhaul transport network performance of one or more access points in the radio network of the second type.

47. The method in claim 46, wherein the radio network of the first type is a cellular radio network and the radio network of the second type is a wireless local area network (WLAN).

48. The method in claim 47, wherein the cellular radio network is a 3GPP cellular radio network, the WLAN is a Wi-Fi network based on one or more IEEE 802.11 protocols, the network node includes an Access Network Discovery and Selection Function (ANDSF) and the received UE access point data includes IEEE 802.11u PassPoint Access Network Query Protocol (ANQP) elements.

49. A user equipment (UE) for conducting radio communications, the UE comprising:
first radio circuitry configured to establish radio communications service with a radio network of a first type and to receive from the radio network of the first type information including parameters for scanning for radio access points in a radio network of a second type different from the radio network of the first type;
second radio circuitry configured to communicate with a second different type of radio network;
control circuitry configured to control the second radio circuitry to scan access points in the radio network of the second type based on the received information and detect access point data, and to control the first radio circuitry to report the detected access point data to the radio network of the first type,
wherein the first radio circuitry is configured to receive a signal from the radio network of the first type to switch radio communications service from the radio network of the first type to one of the access points in the radio network of the second type, and wherein the control circuitry is configured to switch, in response to the received signal, radio communications service from the radio network of the first type to one of the access points in the radio network of the second type.

50. The UE in claim 49, wherein the control circuitry is configured to detect a situation indicating that the UE should begin the scanning step, and in response to the detected situation, to control the second radio circuitry to scan access points in the radio network of the second type based on the received information and detecting access point data.

51. The UE in claim 49, wherein the scanning parameters include one or more rules indicating under what condition the UE should scan access points and what specific information the UE should obtaining from the scanning and report to the radio network of the first type.

52. The UE in claim 51, wherein the one or more rules define one or more of the following: a frequency of scanning by the UE, a threshold defining a minimum signal parameter to initiate the scanning, a UE battery level to initiate the scanning, an application type on the UE to initiate the scanning, a data processing unit utilization level, an UE accelerometer value to initiate the scanning, a UE position to initiate the scanning, and a mobility state of the UE to initiate the scanning.

53. The UE in claim 52, wherein the specific information includes one or more of: a load of one or more access points in the radio network of the second type, one or more supported roaming partners, a type of network security provided by the radio network of the second type, a radio link performance associated with one or more access points in the radio network of the second type, or a backhaul transport network performance of one or more access points in the radio network of the second type.

54. The UE in claim 53, wherein the radio network of the first type is a cellular radio network and the radio network of the second type is a wireless local area network (WLAN).

55. The UE in claim 54, wherein the cellular radio network is a 3GPP cellular radio network, the WLAN is a Wi-Fi network based on one or more IEEE 802.11 protocols, the 3GPP cellular network includes an Access Network Discovery and Selection Function (ANDSF) which either pushes to the UE or has the UE pull a set of rules to be used by the UE to start scanning for Wi-Fi access, and wherein the specific information includes some IEEE 802.11u PassPoint Access Network Query Protocol (ANQP) elements, relevant to be reported back to the 3GPP network.

56. A network node in a radio network of a first type in which radio communications service is provided by the radio network of the first type to a user equipment (UE) comprising:
a radio network interface configured to send or to have sent, to the UE, information including parameters indicating how the UE is to scan for radio access points in a radio network of a second type different from the radio network of the first type and to receive from the UE access point data detected by the UE scanning access points in the radio network of the second type in accordance with the sent information; and
control circuitry configured to generate a signal instructing the UE to switch radio communications service from the radio network of the first type to one of the access points in the radio network of the second type based on the received access point data from the UE and to control the radio network interface to send the signal.

57. The network node in claim 56, wherein the information includes specific information at which the UE should begin scanning access points in the radio network of the second type including one or more of the following: a weakening of signal strength or a lessening of signal quality from the radio network of the first type, a frequency of scanning by the UE, a threshold defining a minimum signal parameter to initiate the scanning, a UE battery level to initiate the scanning, an application type on the UE to initiate the scanning, a data processing unit utilization level, an UE accelerometer value to initiate the scanning, a UE position to initiate the scanning, and a mobility state of the UE to initiate the scanning.

58. The network node in claim 57, wherein the received UE access point data includes one or more of: a load of one or more access points in the radio network of the second type, one or more supported roaming partners, a type of network security provided by the radio network of the second type, a radio link performance associated with one or more access points in the radio network of the second type, and a backhaul transport network performance of one or more access points in the radio network of the second type.

59. The network node in claim 58, wherein the radio network of the first type is a cellular radio network, the radio network of the second type is a wireless local area network (WLAN), the cellular radio network is a 3GPP cellular radio network, the WLAN is a Wi-Fi network based on one or more IEEE 802.11 protocols, the network node includes an Access Network Discovery and Selection Function (ANDSF) and the received UE access point data includes IEEE 802.11u PassPoint Access Network Query Protocol (ANQP) elements.

60. The network node in claim 56, wherein the switch is a network-controlled handover of the UE from the radio network of the first type to one of the access points in the radio network of the second type.
